(19) United States
(12) Patent Application Publication
(10) Pub. No.: US 2009/0110776 A1
(43) Pub. Date: Apr. 30, 2009

(54) STAND-ALONE HOT-PREPARATION DEVICE FOR CONVENIENCE FOOD PRODUCTS, PARTICULARLY INSTANT HOT BEVERAGE MAKER

(76) Inventor: Reinhold WEIN, Erlangen (DE)

Correspondence Address: BROWDY AND NEIMARK, P.L.L.C.;624 NINTH STREET, NW, SUITE 300, WASHINGTON, DC, 20001-5303, US

(21) Appl. No.: 12/237,766

(22) Filed: Sep. 25, 2008

(30) Foreign Application Priority Data
Sep. 25, 2007 (DE) 10 2007 045 784.9

(51) Int. Cl. B65D 81/34; B65D 85/804; A23L 1/40; A23L 2/395; A23F 3/30; A23F 5/36

(52) U.S. Cl. 426/79; 426/109

(57) ABSTRACT

A stand-alone hot-preparation device for convenience food products, particularly instant beverage maker, includes
a reservoir of the food product to be prepared,
a supply container filled with a preparation liquid, particularly water,
a preparation chamber for the food product to be prepared, and
a flow heater device comprising
   an exothermic-reaction-based heat source that can be activated when needed, and
   a heat exchanger unit that is heatable by the heat source, with the aid of which the preparation liquid is transportable under evaporation from the supply container via a length of tubing to the preparation chamber under activation of the food product reservoir.

### BACKGROUND OF THE INVENTION

1. Field of the Invention

The invention relates to a stand-alone hot-preparation device for convenience food products, particularly instant hot beverage maker.

2. Background Art

Regarding the background of the invention it can be stated that changed consumer habits have led to a strong trend over the past few years toward fast, ready-to-eat food products and ready-to-drink beverages. For example, an increasing number of ready-made meals are being offered that, for example, only need to be heated with the aid of a microwave oven, or prepared by adding hot water. Meals of the latter type include, for example, instant soups in foil-sealed single serve cups.

In connection with hot drinks, such as coffee or tea, a strong increase in consumption away from home has become noticeable over the past few years as well. This increase has been particularly drastic in the sale of so-called “one-cup servings,” which are sold primarily based on instant coffee in a wide variety of flavors, such as espresso or café´ crema. The sales channels are quite varied, such as for example single-cup vending machines in public buildings, so-called coffee shops, or—analogous to the above-mentioned instant soups—single-portion packages of types of instant coffee to which hot water needs to be added.

All of the above-discussed packaging formats of hot-consumable convenience foods are not “stand-alone” in the sense that after purchasing a single serve package that is ready-made for final preparation, it would be possible to prepare it independently of a hot water source. The single servings of coffee, for example, which are generally packaged in pouches, require a cup and hot water that needs to be added.

It is true that, in principle, stand-alone heat devices are known from the prior art for ready-to-serve meals, which use a heat source based on exothermic reactions that can be activated when needed. WO 94/11682 A1, WO 01/91621 A1, or WO 2006/009 878 A2 may be mentioned as examples. However, these printed publications each disclose heating devices for food products in which merely a heat transfer takes place from the heat source to the food product. A genuine preparation, for example in the sense of brewing a hot instant beverage or preparing instant soup by adding hot water is not provided for in the prior art.

### SUMMARY OF THE INVENTION

Proceeding from the described problems of the prior art, the invention is based on the object of providing a stand-alone hot-preparation device for convenience food products, with the aid of which a hot food product or a hot beverage can be prepared independently of any external supply with hot water for example.

This object is met with by the present invention, according to which there are provided:
a reservoir of the food product to be prepared,
a supply container filled with a preparation liquid, particularly water,
a preparation chamber for the food product to be prepared, and
a flow heater device, comprising
   an exothermic-reaction-based heat source that can be activated when needed, and
   a heat exchanger unit that is heatable by the heat source, with the aid of which the preparation liquid is transportable under evaporation from the supply container via a length of tubing to the preparation chamber under activation of the food product reservoir.

Based on this combination of features, the hot-preparation device can, as an independent sales unit, keep ready a reservoir of a serving of coffee, for example, that is housed in a preparation chamber. The hot-preparation device can furthermore do without with an external supply of a preparation liquid, such as, for example, water since an appropriate container with a supply thereof is integrated. Heating and transportation thereof to the food product can be accomplished by means of the flow heater device, which advantageously thereby fulfills a typical dual function.

Recognizably, the hot-preparation device will be particularly useful while traveling, for trips into nature, as an “iron ration” for the “quick coffee thirst,” etc. Because of its simple design, the hot-preparation device, despite its complete spectrum of functions, is so cost-effective to produce that it is suitable as one-way packaging for single-portion sales units.

The invention further includes advantageous improvements of the hot-preparation device, whose characteristics, details and advantages will become apparent from the following descriptions of an exemplary embodiment in conjunction with the appended drawings.

### BRIEF DESCRIPTION OF THE DRAWINGS

FIG. 1 shows a schematic section through a hot-preparation device in its initial state,

FIG. 2 shows a section through the hot-preparation device analogous to FIG. 1 with a prepared hot beverage, and

FIG. 3 shows a detail section through the heat exchanger unit of the flow heater device.

### DESCRIPTION OF THE PREFERRED EMBODIMENT

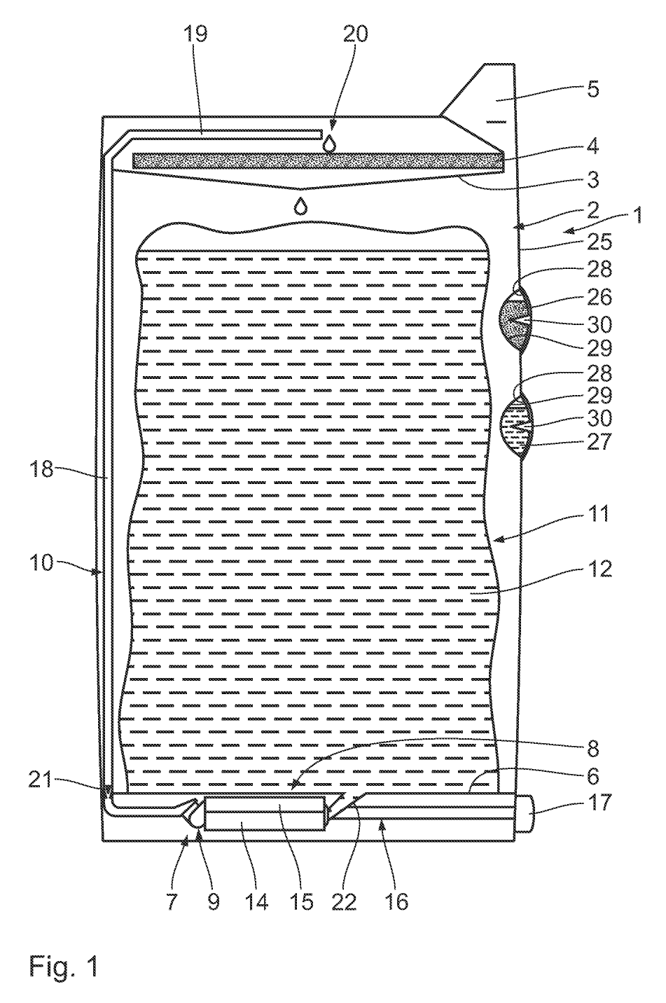

FIG. 1 shall be used to explain the basic design of the hot-preparation device. It has a cup-like base container 1, for example of a heat resistant plastic material that houses the entire internal components of the hot-preparation device and functions in its initial state as an outwardly hermetically closed sales unit. The largest part of the base container 1 is taken up by the preparation chamber 2, for example for a portion of brewable coffee. Provided above the preparation chamber 2, as a reservoir for the food product to be prepared in the present example is a filter bed 3 with coffee powder 4 disposed thereon. Formed laterally of the filter bed 3 at a peripheral location is a drinking spout 5, which is closed in the initial state by a not specifically shown foil cover for hermetic sealing of the preparation chamber 2.

Disposed below the bottom 6 of the preparation chamber 2 is the flow heater device, marked in its entirety with 7, with its main components, namely a heat source 8 and the heat exchanger unit 9 that is routed through the former in the form of a helical tube 23 (see FIG. 3) that is disposed inside a length of tubing 10 between the supply container 11—which will be explained in more detail below—for the brewing water 12 and the filter bed 3 above the preparation chamber 2.

The supply container 11 is a pouch of flexible foil material that takes up a large portion of the preparation chamber 2 when filled with brewing water 12, but is separate with its foil walls from the wall of the preparation chamber 2. As brewing water 12 is removed from the pouch, the same is able to collapse and free up the preparation chamber 2 for the prepared coffee.

The heat source 8 has—as is apparent particularly from FIG. 3—two chambers 13, 14, each of which is filled with a reactant. The two chambers 13, 14 are separated from each other by a membrane 15 that can be torn open by means of a trigger means in the form of a push rod 16 that is movable inside a guide underneath the bottom 6 of the preparation chamber 2. The push rod is actuated by means of a push button 17 that is accessibly affixed on the outside of the base container 1 for activation of the preparation device.

The two reactants are, for example, potassium hydroxide powder, on one hand, and iron (III) chloride solution on the other hand. Experiments in the early stages of the development of the invention have shown that in order to heat 200 ml water from approximately 20° C. to a final temperature of 94° C. with a temperature maximum above the boiling point of water, 15 g potassium hydroxide powder and 10 g iron (III) chloride in 20 to 30 ml water are sufficient in order to bring the above-mentioned 200 ml water to a boil within five minutes upon triggering a spontaneous reaction by tearing open the membrane 15 and mixing these two reactants.

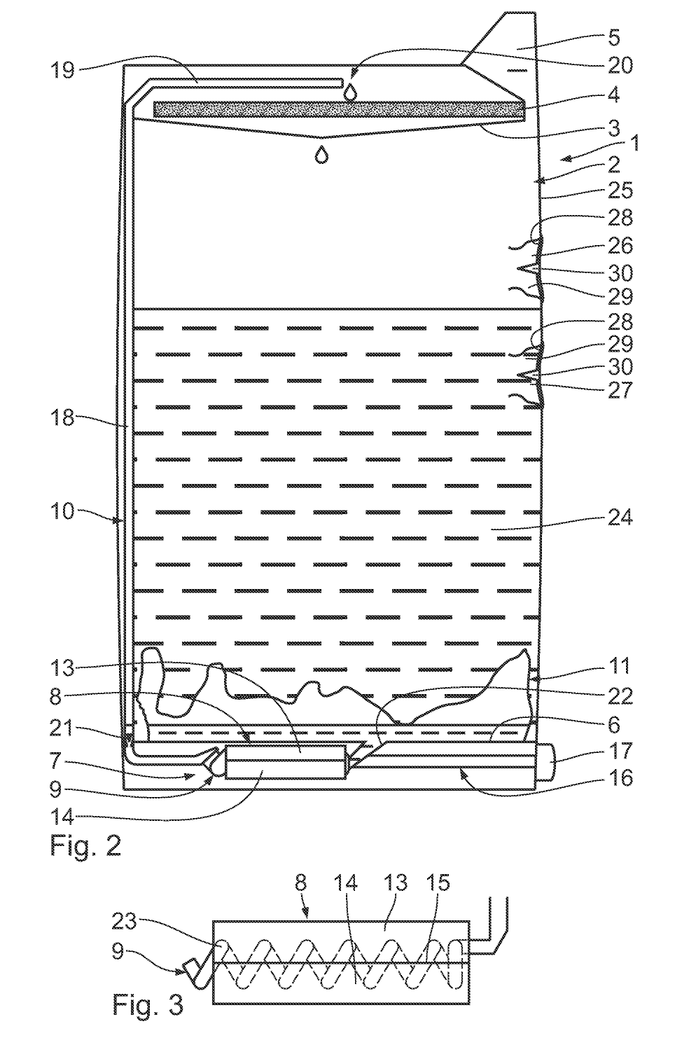

This takes place with the above-mentioned flow heater device 7 that brings the brewing water 12 that enters from the supply container 11 into the heat exchanger 9 to a boil upon activation of the heat source 8. The steam that is created in the process is thus caused to rise in the riser section 18 of the tubing 10 to the filter bed 3 where the coffee powder 4 is exposed to the hot—in the meantime recondensed—brewing water 12 exiting from the feeder section 19 of the tubing 10, and hot filtered coffee runs into the preparation chamber 12. The latter is gradually freed up by the water supply being used up in the storage pouch 11. After depletion of the supply of brewing water 12, the collapsible supply pouch 11—as is apparent from FIG. 2—has collapsed all the way to the bottom of the preparation chamber 2. The latter is filled with the hot, freshly brewed coffee 24, which can be consumed from the drinking spout 5 of the supply container 1.

To prevent condensed water from flowing from the riser section 18 back into the heat exchanger 9, there additionally is provided at the lower end of the riser section 18 a one-way valve 21. It may also be disposed alternatively or additionally in the short connecting section 22 between the outlet of the supply container 11 in the bottom 6 of the base container 1 and the heat exchanger 9.

Various measures may additionally be provided for handling the hot container 1 and for optimizing the thermal conditions. For example, the outer wall of the base container 1 may have a temperature-dependent coloring, which, upon activation of the preparation device and correspondingly hot content in the supply container 1, may take on a conspicuous warning color. The bottom 6 may be made of a thermally particularly well conducting material, in order to ensure through the residual heat of the heat source 8 that the hot beverage 24 in the preparation chamber 2 is kept warm.

As is not specifically shown in the drawings, for preparation of a serving of soup an appropriate instant-soup powder may be stored directly in the preparation chamber 2 around the supply container 11. The filter bed 3 can then be dispensed with, the water for preparation of the serving of soup can drip directly from the feeder section 19 of the tubing 10 onto the soup powder until, again, the supply pouch 11 collapses and the entire water has been transported from it into the preparation chamber 2 with the aid of the flow heater device 7 while being heated.

As is also not specifically apparent from the drawings, in lieu of the drinking opening 5, the upper section 20 of the base container 1 may also be designed separable as a lid from the remaining container in order to permit, for example, the use of a spoon for consuming the serving of soup that is kept ready in the preparation chamber 2.

Lastly, the base container 1 may have reservoirs 26, 27 integrated into its wall 25, for example for sugar or sweetener and milk powder. These reservoirs 26, 27 are provided in each case between an inner wall section 28 and outer wall section 29. The latter is deformable through finger pressure and has on its inside a piercer 30, with the aid of which, upon pressure actuation from outside onto the outer wall section 29, the inner wall section is pierced and the respective reservoir 26, 27 is opened.

Accordingly, the coffee 24, for example, that is available in the preparation chamber 2 can be consumed in the form of sweetened coffee with milk.

What is claimed is:

1. A stand-alone hot-preparation device for convenience food products, comprising
a reservoir (4) of the food product to be prepared,
a supply container (11) filled with a preparation liquid (12),
a preparation chamber (2) for the food product to be prepared, and
a flow heater device (7) including
an exothermic-reaction-based heat source (8) that can be activated when needed, and
a heat exchanger unit (9) that is heatable by the heat source (8), with the aid of which the preparation liquid (12) is transportable under evaporation from the supply container (11) via a length of tubing (10) to the preparation chamber (2) under activation of the food product reservoir (4).

2. A preparation device according to claim 1, wherein the preparation device is an instant beverage maker.

3. A preparation device according to claim 1, wherein the preparation liquid (12) is water.

4. A preparation device according to claim 1, wherein for preparing brewed coffee, the food product reservoir is formed by a filter bed (3) with coffee powder (4).

5. A preparation device according to claim 1, wherein for preparation of an at least partially soluble or directly brewable food product, such as instant soup or tea, the food product reservoir is disposed directly in the preparation chamber (2).

6. A preparation device according to claim 1, wherein the supply container for the preparation liquid (12) is formed by a flexible pouch (11) that is collapsible by emptying, which in its filled initial state is situated in the preparation chamber (2).

7. A preparation device according to claim 1, wherein the heat source (8) of the flow heater device (7) has two exothermically reacting reactants that are housed in adjoining chambers (13, 14), which are separated by a membrane (15) that can be torn open by means of a triggering means (16), and which can be brought into contact with each other for an exothermic spontaneous reaction by tearing open said membrane (15).

8. A preparation device according to claim 7, wherein the reactants are formed by potassium hydroxide powder and iron (III) chloride solution.

9. A preparation device according to claim 7, wherein the heat exchanger unit (9) of the flow heater device (7) is formed by a helical tube (23) extending through the chambers (13, 14) inside the tubing (10).

10. A preparation device according to claim 7, comprising an externally activated push rod (16) for tearing open the membrane (15).

11. A preparation device according to claim 1, wherein the heat source (8) and heat exchanger unit (9) of the flow heater device (7) are disposed below a bottom (6) of the preparation chamber (2) and supply container (11), and wherein the evaporated preparation liquid (12) is supplyable from above via a riser (18) to the food product reservoir (4) and preparation chamber (2).

12. A preparation device according to claim 9, wherein disposed in the tubing (10) for the preparation liquid (12) is it at least one one-way valve (21).

13. A preparation device according to claim 1, wherein the preparation chamber (2) is provided with one of a drinking opening (5) or lid.

14. A preparation device according to claim 1, wherein integrated into a wall (25) of the base container (1) are reservoirs (26, 27) for additional flavoring agents that are emptyable into the preparation chamber (2) through activation from outside.
